(19) United States
(12) Patent Application Publication
(10) Pub. No.: US 2020/0096144 A1
(43) Pub. Date: Mar. 26, 2020

(54) UNIVERSAL PROTECTOR FOR GARDEN HOSE ENDS

(71) Applicant: Patrick Simon, Andale, KS (US)

(72) Inventor: Patrick Simon, Andale, KS (US)

(21) Appl. No.: 16/138,327

(22) Filed: Sep. 21, 2018

(51) Int. Cl. F16L 35/00; F16L 15/00

(52) U.S. Cl. CPC F16L 35/00; F16L 2201/20; F16L 15/006

(57) ABSTRACT

A universal protector for garden hose ends, including a first main body half having a semi-cylindrical shape, a second main body half having a semi-cylindrical shape, and a hinge to connect the first main body half to the second main body half.

### BACKGROUND

### 1. Field

The present general inventive concept relates generally to a guard for a garden hose, and particularly, a universal protector for garden hose ends.

### 2. Description of the Related Art

Proper hose routing, abrasion-resistant covers, and protective guards or sleeves can extend the hose life while increasing safety. A wide variety of hose guards, protectors, sleeves and strain relievers are available to protect hydraulic hose and tubing, helping to eliminate damage caused by extreme heat, and water abrasion in order to extend the life of the hose assembly.

However, there is a need for a universal protector for garden hose ends.

### SUMMARY

The present general inventive concept provides a universal protector for garden hose ends.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a universal protector for garden hose ends, including a first main body half having a semi-cylindrical shape, a second main body half having a semi-cylindrical shape, and a hinge to connect the first main body half to the second main body half.

The hinge may include a connecting portion to connect the first main body half to the second main body half, and a spring to allow the first main body half and the second main body half to be elastically connected to each other.

The first main body half may include a first side wall disposed at a first end of the first main body half, and a second side wall disposed at a second end of the first main body half, and the second main body half may include a first side wall disposed at a first end of the second main body half, and a second side wall disposed at a second end of the second main body half.

The first side wall and the second side wall of the first main body half, when in contact with the first side wall and the second side wall of the second main body half, may prevent the universal protector for garden hose ends from moving past an area of a male end of the garden hose when connected to a female end of the garden hose.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side view of an open universal protector for garden hose ends, according to an exemplary embodiment of the present general inventive concept; and

FIG. 2 illustrates a side view of the universal protector for garden hose ends as installed on a garden hose, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

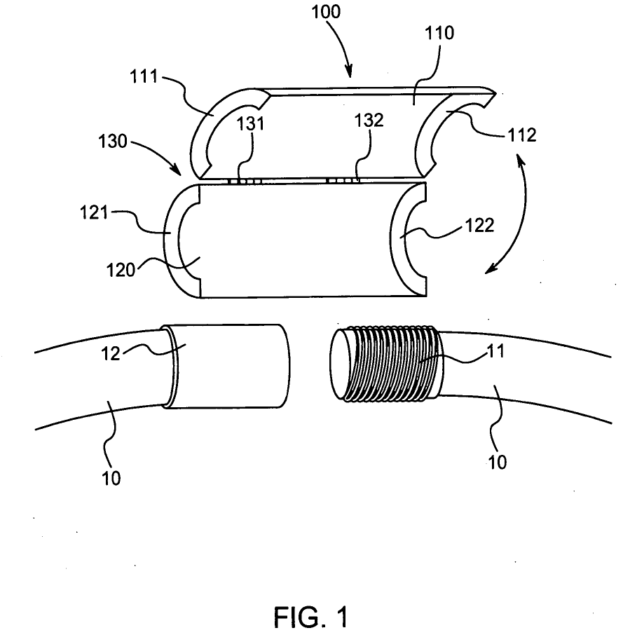

FIG. 1 illustrates a side view of an open universal protector for garden hose ends 100, according to an exemplary embodiment of the present general inventive concept.

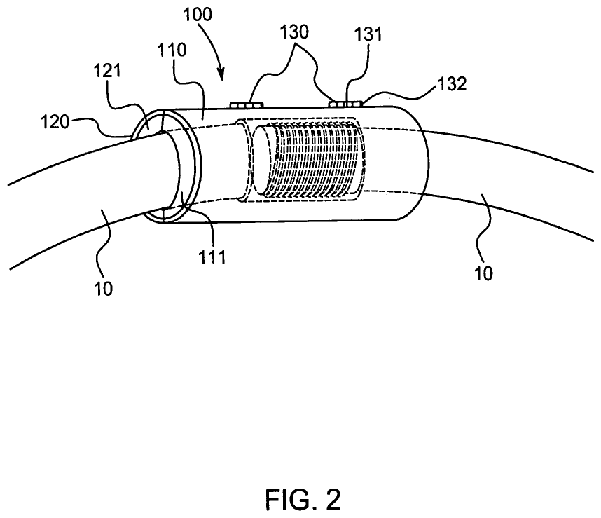

FIG. 2 illustrates a side view of the universal protector for garden hose ends 100 as installed on a garden hose 10, according to an exemplary embodiment of the present general inventive concept.

The universal protector for garden hose ends 100 may be constructed from metal, plastic, cloth, glass, or any other material known to one of ordinary skill in the art.

Referring to FIGS. 1 and 2, the universal protector for garden hose ends 100 may include a first main body half 110, a second main body half 120, and a hinge 130, but is not limited thereto.

The first main body half 110 and second main body half 120 may be rounded and designed to fit around any type of garden hose 10. In other words, the first main body half 110 and second main body half 120 may each have a shape of a semi-cylinder.

The first main body half 110 may include a first side wall 111 disposed at a first end of the first main body half 110, and a second side wall 112 disposed at a second end of the first main body half 110.

The second main body half 120 may include a first side wall 121 disposed at a first end of the second main body half 120, and a second side wall 122 disposed at a second end of the second main body half 120.

The first side wall 111 and the second side wall 112, when in contact with the first side wall 121 and the second side wall 122, may prevent the universal protector for garden hose ends 100 from moving past an area of a male end 11 of the garden hose 10 when connected to a female end 12 of the garden hose 10.

The hinge 130 may include a connecting portion 131 to connect the first main body half 110 to the second main body half 120, and a spring 132 to allow the first main body half 110 and the second main body half 120 to be elastically connected to each other. In other words the spring 132 may force the first main body half 110 and the second main body half 120 to be drawn to each other, such that the first main body half 110 and second main body half 120 are predisposed to be closed with respect to each other.

The first main body half 110 and the second main body half 120 may close over the male end 11 and the female end 12 of the garden hose 10 in order to provide protection therefor

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A universal protector for garden hose ends, comprising:
a first main body half having a semi-cylindrical shape;
a second main body half having a semi-cylindrical shape; and
a hinge to connect the first main body half to the second main body half.

2. The universal protector for garden hose ends of claim 1, wherein the hinge comprises:
a connecting portion to connect the first main body half to the second main body half; and
a spring to allow the first main body half and the second main body half to be elastically connected to each other.

3. The universal protector for garden hose ends of claim 1, wherein:
the first main body half comprises a first side wall disposed at a first end of the first main body half, and a second side wall disposed at a second end of the first main body half; and
the second main body half comprises a first side wall disposed at a first end of the second main body half, and a second side wall disposed at a second end of the second main body half.

4. The universal protector for garden hose ends of claim 1, wherein the first side wall and the second side wall of the first main body half, when in contact with the first side wall and the second side wall of the second main body half, prevents the universal protector for garden hose ends from moving past an area of a male end of the garden hose when connected to a female end of the garden hose.
